(19) United States
(12) Patent Application Publication
(10) Pub. No.: US 2012/0192705 A1
(43) Pub. Date: Aug. 2, 2012

(54) ANTIBALLISTIC ARMOUR PLATE AND A METHOD FOR MANUFACTURING SUCH AN ANTIBALLISTIC ARMOUR PLATE

(75) Inventors: Pål Francis HANSEN, Vesteroy (NO); Bjørn Pettersen, Kråkeroy (NO)

(73) Assignee: FREC TECHNOLOGY AS, Fredrikstad (NO)

(21) Appl. No.: 12/831,727

(22) Filed: Jul. 7, 2010

Related U.S. Application Data
(60) Provisional application No. 61/223,916, filed on Jul. 8, 2009.

(51) Int. Cl. F41H 5/04; B29C 70/02

(52) U.S. Cl. 89/36.02; 156/243; 89/908

(57) ABSTRACT

The invention is an antiballistic armour plate comprising one or more layers of one or more antiballistic ceramic plates laminated with a first, underlying fibre reinforced thermoplastic layer comprising a first thermoplastic material and reinforcement fibres, the antiballistic ceramic plates arranged for receiving and deforming ballistic projectiles or shrapnel, and underlain by a spall liner of one or more loosely bound sheets of antiballistic fibres arranged for receiving the ballistic projectiles or shrapnel having penetrated the ceramic plates. The antiballistic armour plate further has one or more of the antiballistic ceramic plates provided with holes distributed across the one or more ceramic plates, wherein the holes have apertures at least toward the first, underlying thermoplastic layer and provided with a thermoplastic matrix compatible with the first thermoplastic matrix material and provided with reinforcement fibres.

### CROSS REFERENCE TO RELATED APPLICATIONS

This nonprovisional application claims the benefit of U.S. Provisional Application No. 61/223,916 filed on Jul. 8, 2009. The entire contents of the above application is hereby incorporated by reference into the present application.

### INTRODUCTION

Antiballistic shields or protection plates for higher protection classes, rifle ammunition, armour penetrating ammunition, shell shrapnel etc., usually comprises a ceramic core material. Such ceramics have a density from 2.5 to 3.85 g/cm³ and are made of ceramic glass, or sintered ceramics such as Zirconia ZrO₂, Boron Carbide B₄C, Silicone Carbide SiC and Alumina Al₂O₃. The ceramic element of such products has, depending on hardness, grain size distribution, degree of purity, ceramic additives, burning temperature, and compactness, a significant effect in breaking down the projectile as it strikes against and penetrates into the ceramic element, and further in reducing the speed of the projectile. The proportion of the ceramic of such antiballistic shields may constitute up to 95% of the total weight, and may generally be reduced by reducing the thickness of the ceramic component. However, reducing the ceramic component's thickness may significantly incur a reduced antiballistic capacity.

A significant part of the antiballistic properties of the ceramic plate of the shield is due to the strong lamination between the relatively brittle ceramic layer and the high tensile strength fibre reinforced plastic matrix layers in front of and behind the ceramic. An impact of a projectile or shrapnel through the front fibre reinforced layer and penetration into the ceramic, and particularly close second and subsequent impacts, may incur delamination extending further than the projectile's material radius. The deformed projectile may also cause delamination between the rear fibre reinforced layer and the ceramic, a delamination extending significantly wider than the rupture formed from the bullet itself. The delamination is partly due to the local pressure formed and to the extreme local vibrations caused by the strike. If a delamination is produced with a first radius about a stricken part of the antiballistic plate, a subsequent strike within this first radius will not meet a properly laminated antiballistic cross section but in principle a loose, partly cracked ceramic plate, and the shield will not provide the required antiballistic protection against such a subsequent striking projectile.

Some of the problems by antiballistic shields of the background art may me briefly be summarised by the following: The weight of the antiballistic shield is high if a proper protection is required, and the weight is generally determined by the ceramic plate and is sought to be reduced. The extent of the propagation of delamination reduces particularly the multi-hit antiballistic capacity if the impacts are near each other, and should generally be sought reduced. The delamination and crushing of the ceramic plate should generally be sought reduced because an intact part of the ceramic plate increases the possibility to break down the projectile before it breaks through the thermoplastic laminate at the back of the ceramic plate. Further, methods are sought so as for deviating the projectile in order for a component of its velocity may lie along the plane of the ceramic plate or the antiballistic backing.

Armour steel plates constitute a traditional armour material. The advantage is the homogenous structure which gives the steel excellent properties against multi-hits, closely placed impacts, and shrapnel. Crack formation and propagation is thus not an essential problem in connection with multi-hits against steel. Steel is also not particularly expensive and may be welded traditionally or by laser, and may be cut using a high pressure water nozzle or a laser. However, a significant disadvantage to steel is the density and thus the weight required for providing adequate antiballistic protection.

Ceramics for antiballistic plates may be provided with holes, either during the ceramic manufacturing process or by post-treatment of the sintered product using water cutting or diamond cutting. The general idea is that the holes reduce the weight of the antiballistic shield as a hole.

### BRIEF FIGURE CAPTIONS

The invention is illustrated in the attached figures including drawings and photographic renditions.

FIG. 1 is an illustration of a cross section of an antiballistic plate according to the invention having a ceramic layer, here of ceramic tiles, having at least holes from the rear side facing a backing layer of fibre reinforced thermoplastic matrix or other matrix and a spall liner arranged for catching deformed projectiles and splinters which achieve to penetrate the laminated ceramic/FRTP layer.

FIG. 2 is a cross section similar to FIG. 1 in which a majority of the holes are illustrated as through holes, but of which other holes bottom out either at the front or the rear side of the ceramic layer.

FIG. 3 is a cross section similar to FIG. 2 further comprising a front layer of fibre reinforced thermoplastic matrix or other reinforced matrix.

FIGS. 4 and 5 are photographic images of two antiballistic shields having been subject to a ballistic test shooting, each plate having received 5 shots. Each plate has an frtp-ceramic-frtp-spall liner laminate lay-up similar to the cross-section shown in FIG. 3. Each ceramic plate is provided with a hole pattern of a generally six-fold hexagonal symmetry about the centre of each hexagon.

FIG. 4 displays an embodiment of the invention with a ceramic plate having a hexagonal pattern of which the diameter of the holes is about 3 mm and the center-to-center separation between the holes is rather wide, about 5 times the hole diameter. Five consecutively made bullet holes with their predetermined, desired positions may be observed: “1” at the upper right, then “2” at the lower portion in the middle, then “3” in the lower portion to the left of “2”, and “4” immediately to the right of “2”, then “5” just below the middle. Of those, only “1” has missed its target point. A connected delaminated area (D1) is clearly visible between “5”, “3”, and “4”, the delaminated area (D1) also encompassing “2” and extending below this.

FIG. 5 displays another embodiment of the invention with a ceramic plate having a hexagonal pattern of which the diameter of the holes is also about 3 mm and the center-to-center separation between the holes is narrower, about 3.5 times the hole diameter. Also in this test plate five bullet holes have been consecutively shot with their predetermined, desired positions as observed: “1” at the upper right, then “2” at the lower portion in the middle, then “3” in the lower portion to the left of “2”, and “4” immediately to the right of “2”, then “5” just below the middle. Of those, “4” and “5” have significantly missed their target points. The separations between the resulting holes are somewhat larger than for FIG. 4. Separately formed discontinuous delaminated areas (D23, D22, D24) are clearly visible around “3”, “2”, and “4”. Each of the delaminated areas (D23, D22, D24) of FIG. 5 have a halo of generally less extent than for their isolated counterparts of (D1) in FIG. 4 , except for D24 which extends wider to the right portion of “4”.

FIG. 6 is an illustration of a matrix-filled hole in an frtp-ceramic-frtp laminate illustrating an orthogonally binding anti-delaminating property of the matrix through the hole. This may improve the tensile binding strength between the two frontal and backing matrix layers both to each other, but also to the ceramic material itself. Such a matrix-filled hole may thus increase the structural toughness and resist delamination during an impact near the hole. If a delamination zone approaches such a matrix-filled hole, the structural toughness of the laminate at the hole may prevent propagation of a delamination zone across the hole.

FIG. 7 is an illustration of a cross-section of an embodiment of the ceramic laminate layer part of an antiballistic shield according to the invention. Here two layers are shown of which there is arranged a middle layer of fibre reinforced thermoplastic between two layers of ceramic tiles with holes. The tiles may be arranged glued edge to edge, or each layer may be a continuous ceramic plate. In one embodiment the matrix in the holes may carry reinforcing fibres such as short-fibre carbon or glass or Aramide. In an embodiment fibres, chine twist or thin wires may be threaded through the holes and the matrix in the holes so as for improving the binding between the front and the rear layers of fibre reinforced thermoplastic. With reference to FIG. 3, such fibres may be sown back and forth thus binding fibres lying along the front and rear layer of the laminate, and even sown through the spall liner if desired.

FIG. 8 is an illustration of a cross-section of an frtp-ceramic-frtp laminate according to the invention in which holes, which are not all through, are distributed over the front face of the ceramic and also over the rear face of the ceramic plate. Reinforcement fibres may be distributed in the matrix in the holes.

FIG. 9 illustrate roughly a cross-section of an frtp-ceramic-frtp laminate in which the ceramic layer comprises three layers.

FIG. 10 illustrates background art comprising densely arranged centimetre-size rounded cylinders of ceramic material in layers in which all interstices are filled with a hard, tough rubber material.

FIG. 11 roughly illustrates the front tip of a light handgun or machine gun ammunition projectile having a so-called penetrator spearhead for penetrating armour plates.

FIG. 12 illustrates, in the upper part, a section of multilayer ceramic tiles of which the axis of the holes vary from one layer to another layer. In the lower part ceramic layers hole axes have discontinuous directions from one layer to the next.

FIG. 13 illustrates an embodiment of the invention in which inward protruding or outward protruding rifles are formed along the wall of the holes in the ceramic.

FIG. 14 illustrates a general cross-section of an antiballistic plate according to the invention comprising a structural backing metal plate.

In FIG. 15 is illustrated an embodiment of the invention in which one or more of said underlying or frontal thermoplastic fibre reinforced layer is pre-formed provided with knobs fitting with the holes of the ceramic.

### BRIEF SUMMARY OF THE INVENTION

The present invention remedies some of the above-mentioned problems in the background art. The invention is an antiballistic armour plate comprising one or more layers of one or more antiballistic ceramic plates laminated with a first, underlying fibre reinforced thermoplastic layer comprising a first thermoplastic material and reinforcement fibres, the antiballistic ceramic plates arranged for receiving and deforming ballistic projectiles or shrapnel, and underlain by a spall liner of one or more loosely bound sheets of antiballistic fibres arranged for receiving the ballistic projectiles or shrapnel having penetrated the ceramic plates, one or more of the antiballistic ceramic plates provided with holes distributed across the one or more ceramic plates. The holes have apertures at least toward the first, underlying thermoplastic layer and are provided with a thermoplastic matrix compatible with the first thermoplastic matrix material. In an embodiment of the invention the matrix material in the holes is provided with reinforcement fibres.

In a preferred embodiment of the invention the antiballistic armour plate according to the invention the foremost, frontal one of the one or more ceramic layers is laminated with a second, overlying fibre reinforced thermoplastic layer.

In a preferred embodiment of the invention at least the frontal one or more of the holes is provided with a thermoplastic matrix compatible with a thermoplastic matrix material of the second, overlying thermoplastic layer, the thermoplastic matrix provided with reinforcement fibres.

In the antiballistic armour plate of the invention the holes in the ceramic plate have a diameter less than about 3 mm which is a diameter of a penetrator spearhead of commonly used handheld projectiles for handheld guns.

In a preferred embodiment of the invention the reinforcement fibres comprise short fibres, microfibres or nanofibres such as carbon fibres or whiskers.

In an embodiment of the invention one or more of the ceramic layers may be subdivided into ceramic tiles arranged adjacent to each other.

In a preferred embodiment of the invention a plurality of the holes extend through at least one of the ceramic plates.

The holes in one or more of ceramic layers of the antiballistic shield according to the invention contribute to a reduced weight per unit area. With the present invention, we observe through test shootings the unexpected further advantage that the relatively densely arranged holes reduce the formation and propagation of cracks which usually occurs upon impact of a projectile into the ceramic plate of the invention as compared to solid plates of the background art. Further, we see that the crushing of the ceramic material in a widening cone behind the impact point is limited by the holes. The holes of perforated cerams may define zones about the impact which may reduce the crushing radius about the impact point, and may thus improve the laminated ceramic's capacity to resist multi-hits or close subsequent hits reducing the risk of full penetration. In an embodiment of the invention the holes in the ceramic plate are advantageously filled with a thermoplastic matrix increasing the general rupture strength of the laminate.

### Embodiments of the Invention and Discussion of the Embodiments

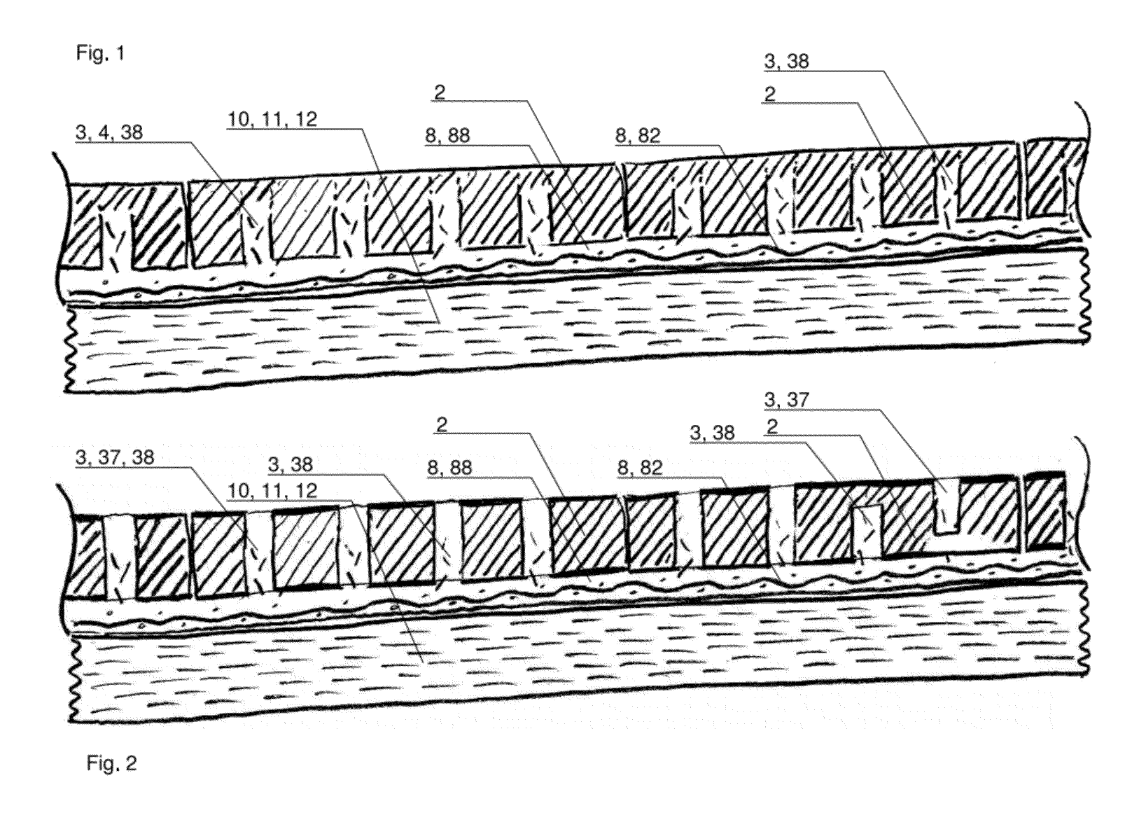

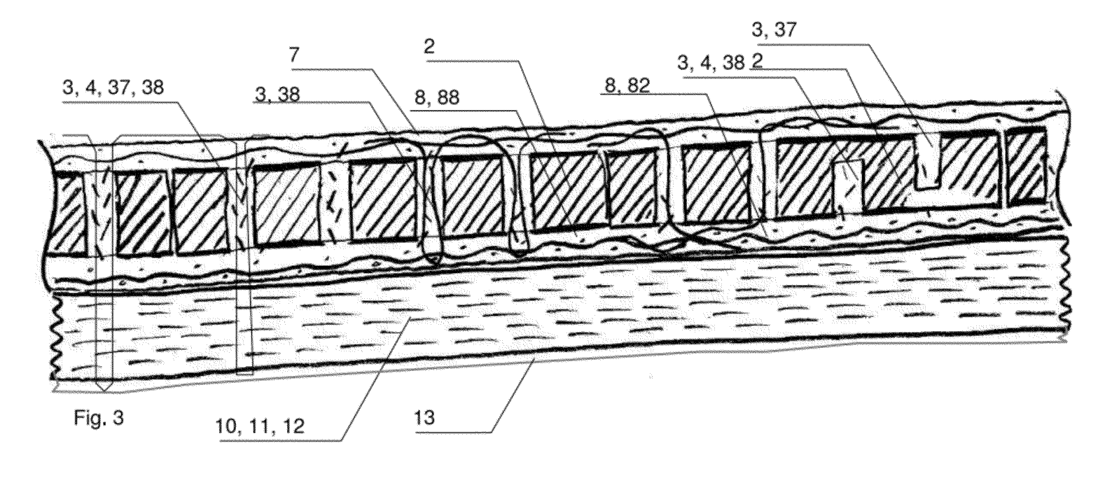

An embodiment of the invention is illustrated in FIGS. 1, 2 and 3 in which is illustrated an antiballistic armour plate. The plate comprises several layers. The front layer is one or more layers of one or more antiballistic ceramic plates (2) laminated with a first, underlying fibre reinforced thermoplastic layer (8) comprising a first thermoplastic material (88) and reinforcement fibres (82). The ceramic plate may be covered by a thermoplastic or other layers. The antiballistic ceramic plate (2) is arranged for receiving and deforming ballistic projectiles or shrapnel in a high energy process of which the projectile and the ceramic plate mutually deform. The ceramic solid material is cracked and crushed which deforms the surface of the metallic projectile thus increasing the mutual friction. The deceleration of the projectile deforms and flattens the projectile and increases the contact area.

The ceramic laminate is backed by a spall liner (10) of one or more sheets (11) of antiballistic fibres (12) arranged for receiving the ballistic projectiles or shrapnel having penetrated the ceramic plates (2). The antiballistic fibres may be Aramide. Further, the antiballistic fibres must be sufficiently loosely bound so as for being enabled to hook or be hooked by a projectile and follow this for a short distance.

One or more of the antiballistic ceramic plates (2) are provided with holes (3, 38) distributed across the one or more ceramic plates (2). The holes (3, 38) have apertures at least toward the first, underlying thermoplastic layer (8) and provided with a thermoplastic matrix (4, 48) compatible with the first thermoplastic matrix material (88) and provided with reinforcement fibres (5, 58). This basic cross-section is illustrated in FIG. 1.

There are several advantages of the antiballistic armour plate of the invention:
The plate has reduced weight compared to solid ceramic plates, or increased thickness using same ceramic mass.
The holes delimit the crack propagation of one hit, providing better multi-hit tolerance.
The laminated plate as a whole has improved lamination strength between the ceramic layer and the first underlying thermoplastic layer, both due to compatibility and thus binding strength between the thermoplastic matrix materials of the holes and the underlying FRTP layer. Further, reinforcement fibres in the holes increase the tensile and shear strength of the thermoplastic material in the holes. This results in improved multi-hit tolerance. If the reinforcement fibres in the holes are more or less connected with the fibres of the overlying FRTP, the reinforcement fibres will further contribute to the lamination strength.

A top, frontal FRTP layer (7) is comprised in a preferred embodiment. This is shown in FIG. 3. The antiballistic armour plate according to the invention may have a laminate layer of a second, overlying fibre reinforced thermoplastic layer (7). The antiballistic armour plate so formed may be provided with one or more of the holes (3) provided with a thermoplastic matrix (4, 47) compatible with a thermoplastic matrix material of the second, overlying thermoplastic layer (7). The thermoplastic matrix (4, 47) is provided with reinforcement fibres (5, 57). The holes (3, 37) may be through holes or open toward the front of the ceramic.

There are advantages to such an embodiment of the invention:
The contact between the matrix of the frontal open holes and the frontal matrix layer provides improved lamination strength between the ceramic layer and the second, overlying thermoplastic layer, both due to compatibility and thus binding strength between the thermoplastic matrix materials of the holes and the overlying FRTP layer, and that reinforcement fibres in matrix in the holes increase the tensile and shear strength of the thermoplastic material in the holes.

In an embodiment of the antiballistic armour plate according to the invention the holes (3) have a diameter less than about 3 mm which is a diameter of a penetrator spearhead of commonly used handheld projectiles for handheld guns.

It is assumed that it is possible to reduce the areal density of the ceramic element up to 40% by forming holes in the ceramic plate.

The present production process of the applicant, the company Frec, is to vacuum bake fibre reinforced thermoplastic cloths to the front and the rear of the ceramic plate and usually behind the rearmost package of antiballistic cloths forming the spall liner. This is a highly efficient and durable encapsulation of antiballistic ceramic plates. It should be reasonable to believe that the new feature of matrix-filled and possibly reinforced matrix filled holes through the laminated frtp-ceram-frtp will improve the antiballistic properties including anti-delamination effect and weight. This is particularly valid when a majority of the holes extend through the ceramic tiles, such as illustrated in FIG. 3 and in FIG. 7.

The material of the matrix in the holes should be chemically and mechanically compatible with the material of the thermoplastic matrix at the front and the rear of the ceramic plate. In a preferred embodiment it should be generally the same thermoplastic material, either pre-filled or plugged into the holes or formed by vacuum overflow from melted thermoplastic material during the vacuum baking process.

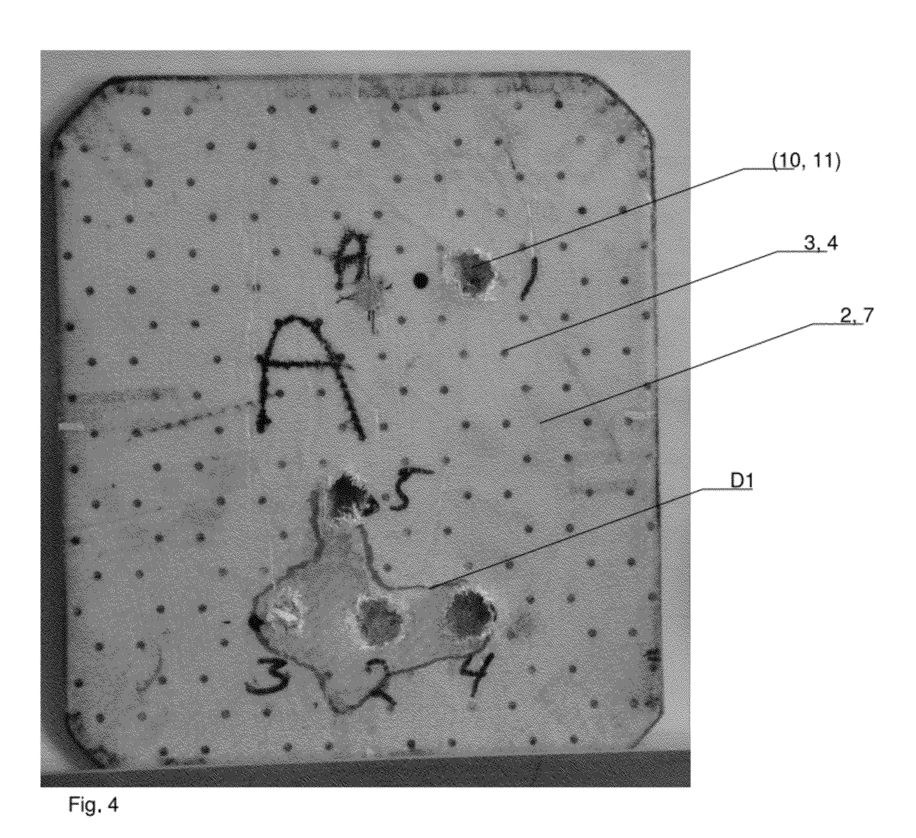

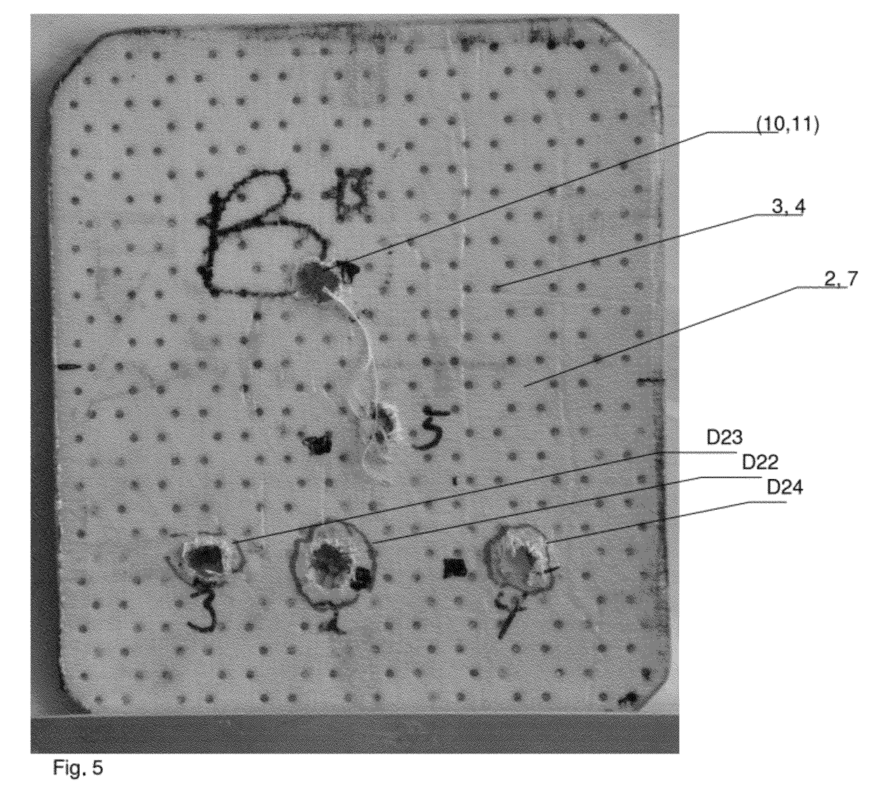

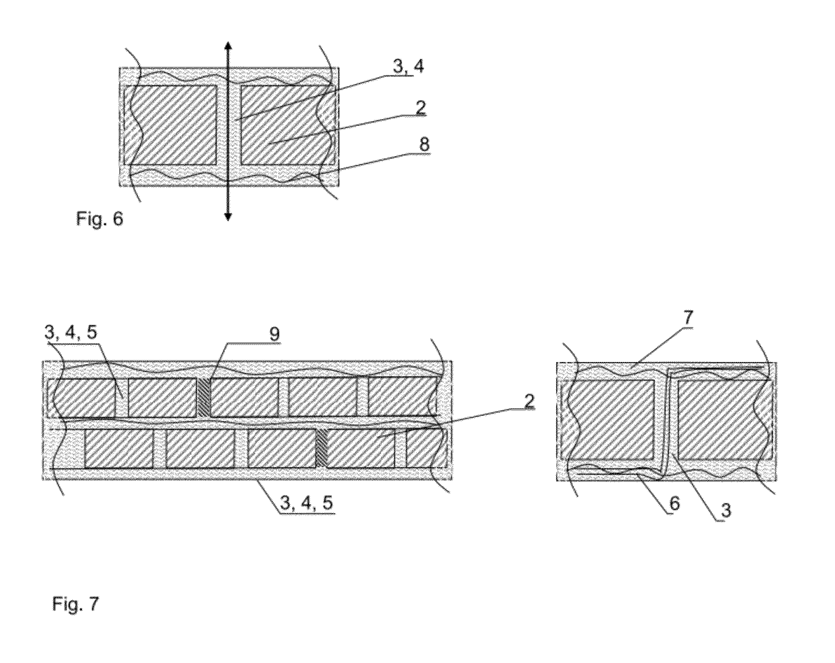

Above was mentioned that a thread such as chine twist may be sown through the holes in the plate. Such a sowing process may be conducted during a dry layup phase before the vacuum baking process is conducted. If the ceramic plates have a regular and predictable pattern such as illustrated in FIG. 4 and in FIG. 5 it is feasible to conduct the sewing process automatically in an industrial sewing machine.

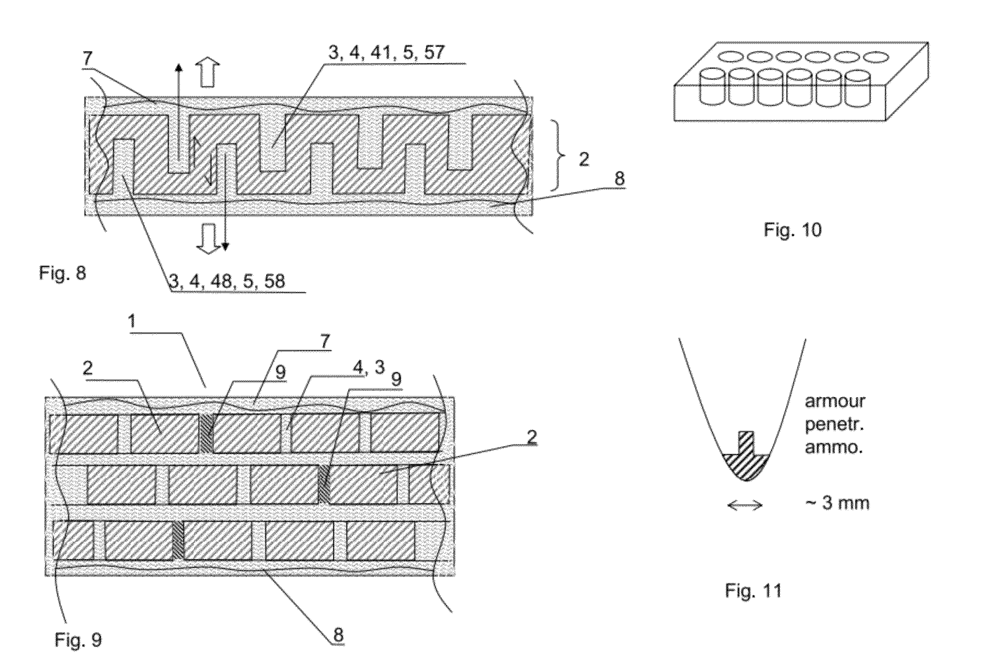

As illustrated in FIG. 8, in an embodiment according to the invention in which holes, which are not through the ceramic, are distributed over the front face of the ceramic and also over the rear face of the ceramic plate, this arrangement of holes may still reinforce the laminate efficiently while retaining a good weight reduction as compared to a ceramic without holes. Reinforcement fibres may be distributed in the matrix in the holes. First, the matrix which forms a continuum with the matrix of the front layer may form anchoring elements in the entire depth of the holes, and the cylindrical surface of the solid matrix forms a cylinder surface area in contact with the wall of the hole. The sum of all such cylinder/hole wall contact surfaces significantly increases the contact area of the front laminate. A significantly increased contact area generally increases the lamination strength and prevents delamination. One will realize that a hole may stop or deviate a crack in the ceramic from propagating across the hole because the matrix of the hole may absorb energy without cracking. In the same manner, during propagation of multiple small cracks constituting a crushing process upon impact of a projectile, the crushing process may stop at the ceramic/matrix interface in the hole. From the above one will see that the matrix-filed holes both contribute to anchoring of the frontal frtp layer to the ceramic layer and thus prevents delamination. This is valid whether the holes are through or nearly through. This is further significantly improved if the matrix in the holes carry reinforcement fibres such as shown in FIGS. 3, 7, and 8. Moreover, the matrix-filled holes counteract the propagation of cracks and crushing along the ceramic layer and thus reduces the vulnerability to multi-hits. Further, the matrix-filled holes significantly contribute to a ceramic weight reduction per area of the ceramic layer, which may be utilized in several ways, first as merely a weight reduction if weight is the main issue such as for personnel or light vehicles, or secondly utilized for increasing the thickness in order to further improve the antiballistic capacity of the shield, if weight is not the main issue, such as for heavily armoured vehicles.

In FIG. 8 is illustrated a set of disruptive forces acting on the front and back frtp laminate layers away from the ceramic with reinforced matrix-filled holes. The disruptive forces will set up a tension force in each affected matrix cylinder anchoring the frtp layer to the hole wall. The disruptive forces will transfer as a shear force through the cylinder interface and at least partly propagate as a shear force to the opposite face as illustrated by the half-arrows in FIG. 8. The same is valid for matrix-filled reinforced through holes such as in FIG. 3 while in such situations the tension force in the anchor matrix is also transferred directly through the matrix-filled holes.

FIG. 9 illustrate roughly a cross-section of an frtp-ceramic-frtp laminate according to the invention in which the ceramic layer comprises three layers. The three (two or more) layers of ceramic may be subdivided into tiles. The tiles may be glued end on end in the desired pattern, and the tiles may be plane, kinked or curved depending on whether the shield as such is desired to be plane, curved, or be constituted by two or more planes having sharp or rounded transitions. One or more of the ceramic layers, whether continuous or tiled, are provided with holes. Thermoplastic matrix is arranged in the holes. The matrix fill may be fibre reinforced as for the embodiments above. Between the two or more layers of ceramic thermoplastic may be used. Such a thermoplastic bonding layer may be constituted by a thin film or net or mat of thermoplastic so as forming a dry lay-up for being vacuum pumped and vacuum baked. As an alternative, the ceramic layers may be bonded by other adhesives such as epoxy glue. A thermoplastic binder may be less brittle than an epoxy glue.

FIG. 11 roughly illustrates the front tip of a light handgun or machine gun ammunition projectile having a so-called penetrator spearhead for penetrating armour plates. The holes should have a diameter similar to or less than the diameter of such penetrator spearheads, e.g. 3 mm or less.

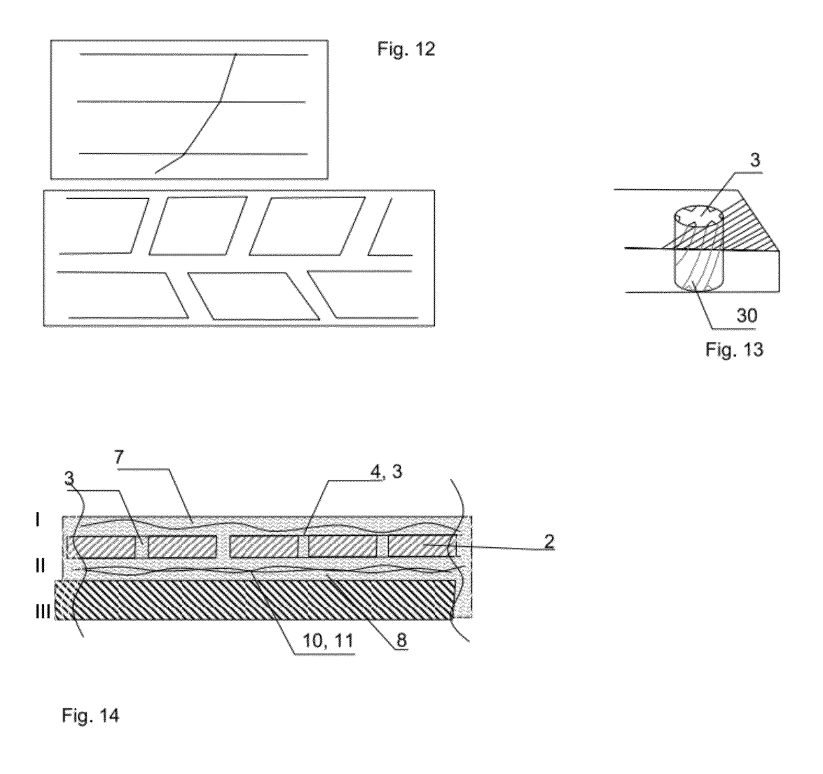

FIG. 12 is an illustration of, in the upper part, a section of multilayer ceramic tiles of which the axis of the holes vary from one layer to another layer. With such a device one may attempt to progressively deviate a near perpendicular impact path away from the perpendicular line and approaching the plane of the ceramic layers so as for increasing the path to be penetrated and to attempt to turn the projectile facing sidewards into the shield. In the lower part ceramic layers hole axes have discontinuous directions from one layer to the next, which may create discontinuities that may disturb the projectile's propagation through the ceramic layer.

FIG. 13 illustrates an embodiment of the invention in which inward protruding or outward protruding rifles are formed along the wall of the holes in the ceramic. Such rifles, whether protruding inwards or outwards from the wall will create ribs that increases the area of the generally cylindrical wall of the hole, and thus increases the binding between the ceramic plate and the matrix filling the hole, thus increasing the lamination strength of the frtp-ceram-frtp laminate. Further, the increased area of the cylinder wall may stiffen off the wall locally. A rifled wall may also contribute to predefine break lines through the ceramic thus further delimiting crack or crushing propagation. In an embodiment of the invention the rifles are non-parallel to the axis of the hole.

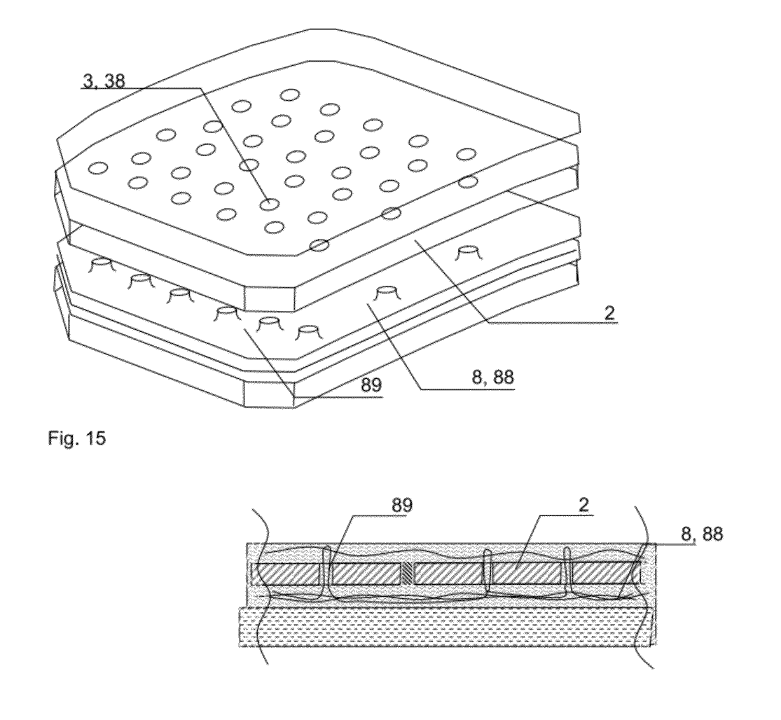

FIG. 14 illustrates a general lay-up of a shield to be formed according to the invention:
I: one or more layers of laminated fibre reinforced thermoplastic laminated with one or more layers of ceramic plates or tiles. Layers I are for fronting impacting projectiles or shrapnel and braking and deforming them during the penetration.
II: one or more layers of spall liner forming textiles. Layers II are for receiving the braked, deformed projectiles and crushed ceramic material having entirely or partly penetrated layers I.
III: an open or solid structural backing usually comprising a steel or aluminium plate. The role of the structural backing may be one or both of simply providing structural support to layers I and II and may thus only form a framework for mounting shields, or being continuous and solid and to provide metallic material toughness for further antiballistic protection.

In FIG. 15 is illustrated an antiballistic armour plate according to the invention in which one or more of said underlying or frontal thermoplastic fibre reinforced layers (8, 7) is pre-formed with knobs (89) arranged for fitting into corresponding holes in one or more of said ceramic antiballistic plates (2).

1. An antiballistic armour plate comprising
one or more layers of one or more antiballistic ceramic plates laminated with a first, underlying fibre reinforced thermoplastic layer comprising a first thermoplastic material and reinforcement fibres, said antiballistic ceramic plates arranged for receiving and deforming ballistic projectiles or shrapnel, and underlain by
a spall liner of one or more loosely bound sheets of antiballistic fibres arranged for receiving the ballistic projectiles or shrapnel having penetrated said ceramic plates;
one or more of said antiballistic ceramic plates provided with holes distributed across said one or more ceramic plates, wherein
said holes having apertures at least toward said first, underlying thermoplastic layer and provided with a thermoplastic matrix compatible with said first thermoplastic matrix material and provided with reinforcement fibres.

2. The antiballistic armour plate of claim 1, a front face of said one or more antiballistic ceramic plates laminated with a second, frontal fibre reinforced thermoplastic layer.

3. The antiballistic armour plate of claim 2,
one or more of said holes in said ceramic plates provided with a thermoplastic matrix compatible with a thermoplastic matrix material of said second, overlying thermoplastic layer,
said thermoplastic matrix provided with reinforcement fibres.

4. The antiballistic armour plate of claim 1,
said holes in said ceramic plates having a diameter less than about 3 mm.

5. The antiballistic armour plate of claim 1,
said reinforcement fibres comprising short microfibers or nanofibers such as carbon fibres or whiskers.

6. The antiballistic armour plate of claim 1,
a plurality of said holes extending through said ceramic plate.

7. The antiballistic armour plate of claim 1, at least a part of said reinforcement fibres being anchored in said thermoplastic backing layer.

8. The antiballistic armour plate of claim 6, at least part of said reinforcement fibres in said holes of said underlying and/or frontal thermoplastic fibre reinforced layers is threaded back and forth through said holes.

9. The antiballistic armour plate according to claim 1, in which one or more of said underlying or frontal thermoplastic fibre reinforced layers is pre-formed with knobs arranged for fitting into corresponding holes in one or more of said ceramic antiballistic plates.

10. The antiballistic armour plate according claim 1, wherein axes of said holes deviate from a perpendicular direction with a frontal surface of said ceramic layer.

11. The antiballistic armour plate of claim 1, wherein said one or more layers of one or more antiballistic ceramic plates is subdivided into ceramic tiles.

12. The antiballistic armour plate of claim 4, wherein said holes in said ceramic plates have a diameter between 0.1 mm and 3 mm.

13. A method of forming an antiballistic armour plate, comprising:
applying at least one or more second layers of dry fibre reinforced thermoplastic cloths on a mould for forming a frontal layer of said armour plate,
arranging one or more ceramic antiballistic plates on said second layers of fibre reinforced thermoplastic cloths, said ceramic plates having holes distributed evenly over the surface of said ceramic plate,
applying at least one or more first layers of dry fibre reinforced thermoplastic cloths on said one or more layers of ceramic plates,
applying one or more spall liner forming antiballistic layers of such as aramide, alternating with relatively weakly binding films on said first layer of thermoplastic fibre reinforced cloths,
vacuum pumping the above formed lay-up,
heating said formed lay-up until a desired degree of melting of a thermoplastic part of said second and first fibre reinforced cloths form all or part of a thermoplastic matrix in said holes of said ceramic plates,
cooling of said vacuum baked lay-up until said melted thermoplastic matrix sets and bind said fibre reinforced lay-up to form said antiballistic armour plate.

14. The method according to claim 13, comprising the step of having applied the spall liner forming antiballistic layers a third layer of one or more dry fibre reinforced thermoplastic cloths for forming a rear enveloping layer behind said spall liner.

15. The method according to claim 13, wherein forming said thermoplastic matrix of said holes generally continuous with said thermoplastic matrix of said first fibre reinforced thermoplastic layer.

16. The method according to claim 13, providing fibre reinforcement also in said matrix in said holes.

17. The method according to claim 16, wherein said fibre reinforcement in said holes is provided by threading, sowing or knitting said first fibre reinforced mat to said one or more ceramic plates using said holes.

18. The method according to claim 17, wherein said fibre reinforcement in said holes form a continuous part of said reinforcement fibres of said first and/or said second layer of fibre reinforced thermoplastic cloths.

19. The antiballistic armour plate of claim 7, at least part of said reinforcement fibres in said holes of said underlying and/or frontal thermoplastic fibre reinforced layers is threaded back and forth through said holes.
